(19) United States
(12) Patent Application Publication
(10) Pub. No.: US 2013/0313001 A1
(43) Pub. Date: Nov. 28, 2013

(54) INSULATOR WITH IMPROVED STRENGTH AND EASE OF INSTALLATION

(71) Applicant: Marko K. LUBIC, Shillington, PA (US)

(72) Inventor: Marko K. LUBIC, Shillington, PA (US)

(73) Assignee: Woodstream Corporation, Lititz, PA (US)

(21) Appl. No.: 13/480,889

(22) Filed: May 25, 2012

(51) Int. Cl. H01B 17/14

(52) U.S. Cl. 174/138 R

(57) ABSTRACT

An insulator with improved strength and ease of installation is provided for use with electric fence systems. The insulator has a body made of a high strength, high toughness polymer and a fastening element for securing the insulator to a fence post or other support member. The head of the body has a drivable structure, preferably a socket, by which the insulator may be installed using a power tool.

### BACKGROUND OF THE INVENTION

1. Field of the Invention

The present invention is related to the field of installation, support and electrical insulation of an electrified fence wire system, typically used to contain livestock and, more particularly, to an improved insulator for use with such a system.

2. Description of the Related Art

Electrically charged containment fences function by sending an electric pulse through a wire that extends around a containment area to form a fence. The wire is supported on posts, building structures or other physical structures spaced from one another along a desired fence path. Contact of an animal with the fence wire completes an electrical circuit through the animal to ground and back to the source of the pulse, creating a shock that deters the animal from attempting to cross the fence.

Since the wire must be supported above the ground by a fence post, a wooden fence post may create an electrical ground. As a result, an insulator must be used as the actual contact point with the wire to prevent losses in electrical potential from the wire attachment point. To ensure the integrity of the fence, the insulators must be able to withstand the stress imposed by the weight and tension of the wiring and also possible impact by an animal. The insulators must therefore be durable, both during installation and use.

Prior art electrical insulators, such as those described in U.S. Pat. No. 2,050,898, are typically made of porcelain. While a good insulating material for preventing the wire from being grounded, porcelain is fragile and difficult to install. Therefore, a need exists for an improved electrical insulator having greater durability and ease of installation.

### SUMMARY OF THE INVENTION

The present invention is directed to an electrical insulator made of a high strength, high toughness polymer, such as high impact polystyrene (HIPS), that is highly resistant to cracking or shattering even when a direct force is applied such as a hammer or the impact of a large animal. The polystyrene insulator includes a drivable structure, preferably a socket, that enables the insulator to be installed using a power tool.

In view of the foregoing, one object of the present invention is to overcome the difficulties of installing prior art ceramic electrical insulators, which is conventionally done with a hand tool.

Another object of the present invention is to provide an electrical insulator with improved durability against breakage.

A further object of the present invention is to provide an electrical insulator in accordance with the preceding objects that is made of high impact polystyrene.

A still further object of the present invention is to provide an electrical insulator in accordance with the preceding objects that includes a drivable structure to allow the insulator to be installed with a power tool.

Yet another object of the present invention is to provide an electrical insulator in accordance with the preceding objects in which the drivable structure is a socket.

A still further object of the present invention to provide an insulating member for use with electric fencing systems that is not complex in structure and which can be manufactured at low cost but yet provides increased durability and ease of installation.

The foregoing objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a top side perspective view of a drivable insulator in accordance with the present invention.

FIG. 2 is a side view of the drivable insulator shown in FIG. 1.

FIG. 3 is a cross-sectional view taken along line A-A of FIG. 2.

FIG. 4 is a top view of the drivable insulator shown in FIGS. 1-3.

### DETAILED DESCRIPTION OF THE PREFERRED EMBODIMENTS

Although only one preferred embodiment of the invention is explained in detail, it is to be understood that the embodiment is given by way of illustration only. It is not intended that the invention be limited in its scope to the details of construction and arrangement of components set forth in the following description or illustrated in the drawings. Also, in describing the preferred embodiments, specific terminology will be resorted to for the sake of clarity. It is to be understood that each specific term includes all technical equivalents which operate in a similar manner to accomplish a similar purpose.

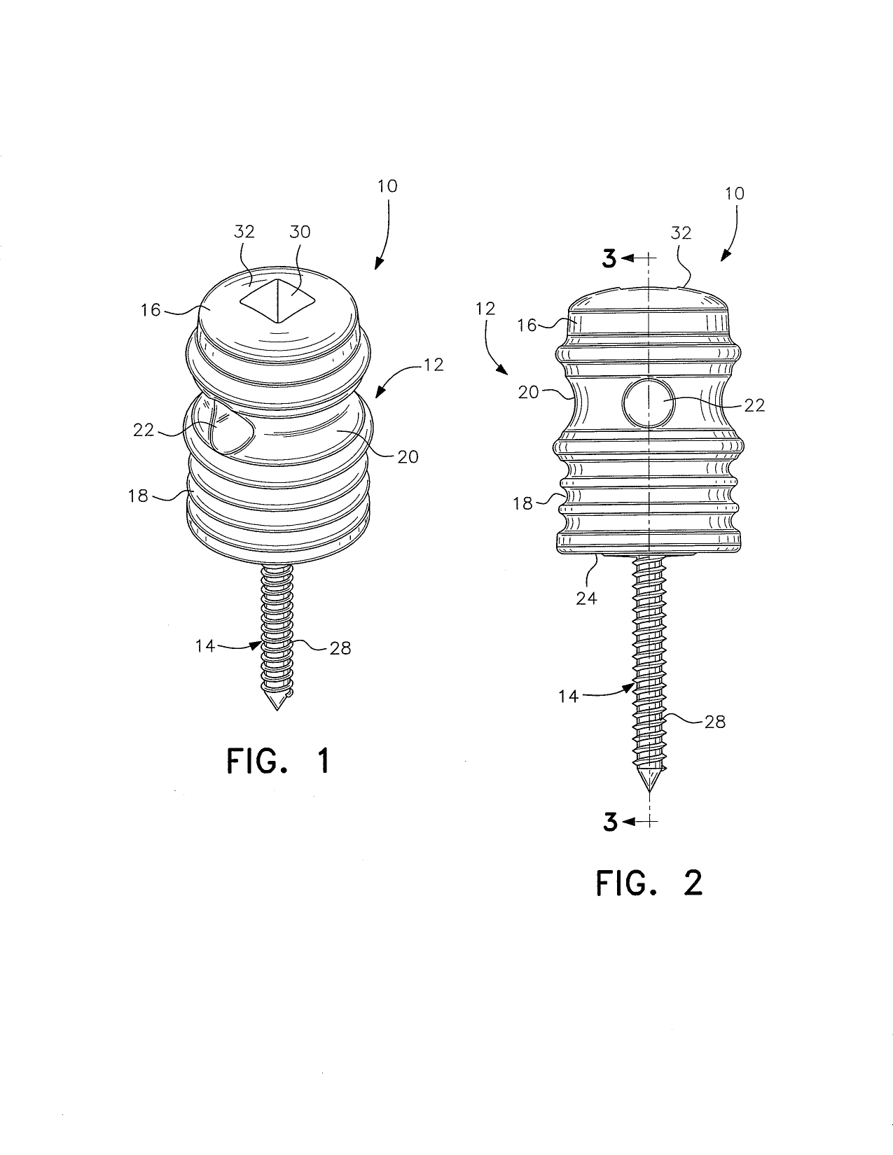

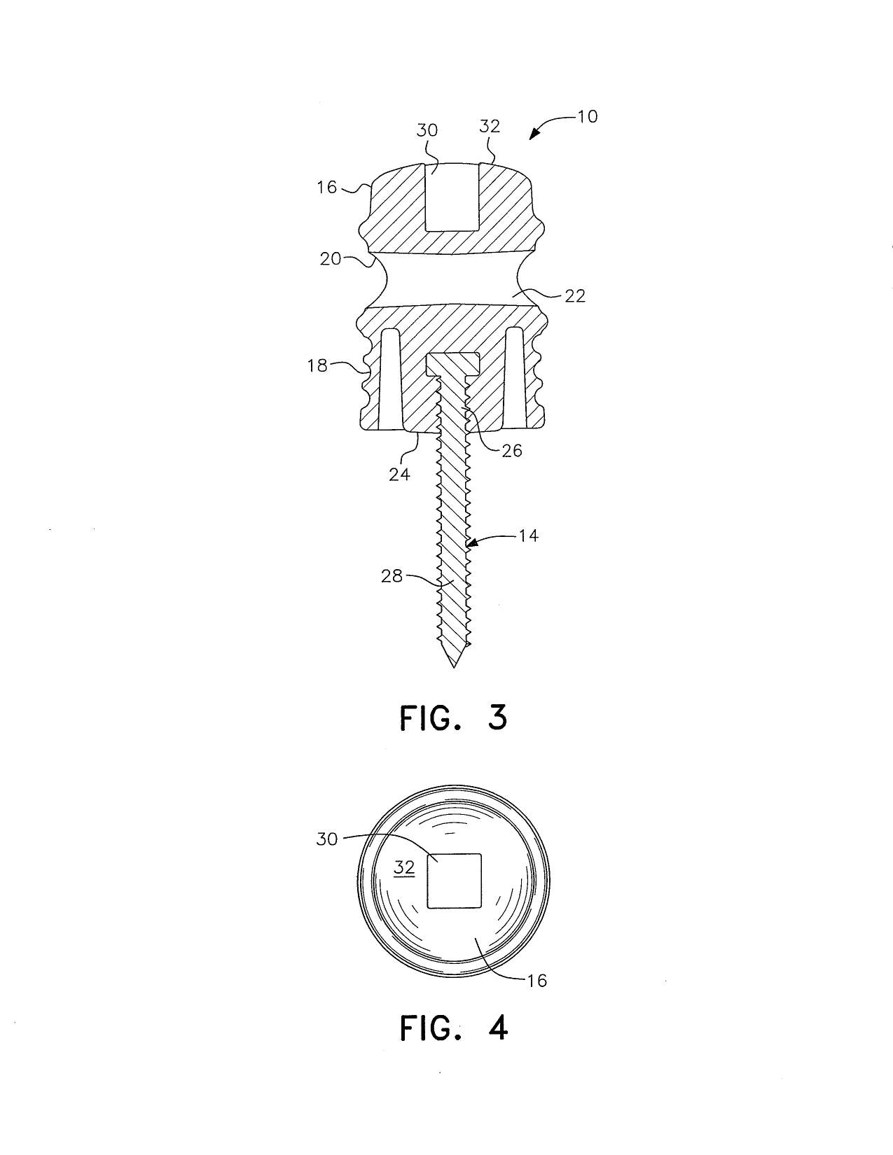

As shown in FIGS. 1-3, the present invention is directed to an insulator generally designated by reference numeral 10. The insulator 10 has a body, generally designated by reference numeral 12, and a fastening element, preferably a screw, generally designated by reference numeral 14. The shape of the body 12 and the size of the screw 14 are preferably similar to conventional porcelain insulators so that the drivable insulator is interchangeable with existing porcelain insulators. Generally, the body of the insulator is between about 1.0 inches to about 4.0 inches in length, and preferably about 2.5 inches in length. The diameter of the insulator body is between about 0.75 inches to about 2.0 inches, and preferably about 1.8 inches. However, the insulator could have various morphological designs without departing from the scope of the present invention.

According to the embodiment shown in FIGS. 1-4, the body 12 includes a head 16 and a base 18 separated by a grooved section 20. A wire supporting element in the form of a hole 22 runs completely through the grooved section 20 parallel to a plane transverse to the length of the body. This hole 22, which is preferably about 0.5 inches in diameter, primarily functions as the canal or channel through which the electrified wire (not shown) passes and is supported. The hole 22 may also be used as a secondary means of installation if the insulator 10 is to be installed using conventional, hand operated, methods.

The body 12 is unitary in construction and is made of a high strength, high toughness, electrical insulating polymer. The minimum specifications for a polymer suitable for the insulator of the present invention are as follows:
1) Strength: tensile strength at break of at least 4500 psi (73° F.);
2) Toughness: impact strength using IZOD impact of ⅛ inch specimen (73° F.) of at least 1.5 ft-lb/in;
3) Electrical insulation: dielectric strength of at least 350 V/mil.

Polymers meeting the above specifications can include, but are not limited to, high impact polystyrene (HIPS), polyamide (PA), polyethylene (PE, HDPE, UHMW), polycarbonate (PC), polyvinyl chlorides (PVC) and polyoxymethylene (POM). The strength of high impact polystyrene, which provides a good balance between performance and cost, or any of the other identified polymers, reduces the likelihood of the insulator cracking or shattering when a direct force is applied to it, such as with a hammer or as the result of a large animal running into it.

The screw 14 protrudes from the bottom 24 of the base 18, generally perpendicular to the hole 22. The screw 14 is used to fasten the insulator 10 to a wooden post or other supporting structure (not shown). Preferably, the screw is about 3 inches in length with an embedded portion 26 that extends about 0.5 inches into the base 18 and a protruding portion 28 that is about 2.5 inches in length. The screw may be made of any suitable screw material but is preferably zinc plated steel. However, any corrosion resistant metal or even a composite polymer could be used. The screw and body could also be of unitary construction using resin polymer such that no metal parts are necessary.

The head 16 of the body 12 includes a drivable structure to enable the insulator to be installed using a power tool. As shown best in FIG. 4, the drivable structure is preferably embodied as a socket 30 that opens toward the top of the upper surface 32 of the head 16. As shown, the socket 30 is generally aligned with the longitudinal axis of the screw 14 to facilitate installation of the insulator 10 with a power tool.

According to one embodiment, the socket 30 is square and designed to accept a conventional 0.5 inch square socket bit so that the insulator may be installed with a socket wrench or a power tool with appropriate bit. Other shapes and configurations for the drivable structure could be used to match corresponding driving structures on a manual or power tool as would be known by persons of skill in the art.

To install the drivable insulator 10 onto a wooden post, the installer holds the insulator so that the screw 14 and the length of the body 12 are parallel to the ground. In this position, the screw is placed substantially perpendicular against the wooden post. The insulator is then driven into the wooden post by applying clockwise torque to the insulator via the socket 30. The socket may be driven using a power tool with appropriate socket bit. Alternatively, the insulator 10 may be driven into the wooden post using a lever, such as a screwdriver, placed into the transverse hole 22. Once the insulator 10 is secured to the wooden post, the electric wire can be run through the transverse hole and to the next wooden post and insulator.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. An insulator used to support wire configured as an electric fence, said insulator comprising a body, a fastening element for securing the body to a support member, and a wire supporting element, said body including a drivable structure separate from said wire supporting element by which the insulator can be mounted to the support member using a power tool.

2. The insulator as set forth in claim 1, wherein said body is made of a high strength, high toughness, electrical insulating polymer.

3. The insulator as set forth in claim 2, wherein said polymer is selected from the group consisting of high impact polystyrene (HIPS), polyamide (PA), polyethylene (PE, HDPE, UHMW), polycarbonate (PC), polyvinyl chlorides (PVC) and polyoxymethylene (POM).

4. The insulator as set forth in claim 2, wherein said high impact polymer has a tensile break strength of at least 4500 psi (73° F.), an impact strength using IZOD impact ⅛ inch specimen (73° F.) of at least 1.5 ft-lb/in, and a dielectric strength of at least 350 V/mil.

5. The insulator as set forth in claim 1, wherein said drivable structure is a socket sized to receive a conventional socket wrench or power tool socket bit.

6. The insulator as set forth in claim 5, wherein said fastening element is a screw that has a top portion embedded in said body.

7. An insulator used to support an electric fence wire, said insulator comprising a body made of a high strength, high toughness polymer and a screw partially embedded in said body and extending therefrom in line with a length of said body for securing the body to a fence post, said body including a drivable structure by which the insulator can be mounted to the fence post using a power tool.

8. The insulator as set forth in claim 7, wherein said polymer is selected from the group consisting of high impact polystyrene (HIPS), polyamide (PA), polyethylene (PE, HDPE, UHMW), polycarbonate (PC), polyvinyl chlorides (PVC) and polyoxymethylene (POM).

9. The insulator as set forth in claim 8, wherein said high impact polymer has a tensile break strength of at least 4500 psi (73° F.), an impact strength using IZOD impact ⅛ inch specimen (73° F.) of at least 1.5 ft-lb/in, and a dielectric strength of at least 350 V/mil.

10. The insulator as set forth in claim 7, wherein said drivable structure is a socket sized to receive a conventional socket wrench or power tool socket bit.

11. The insulator as set forth in claim 10, wherein said socket is in longitudinal alignment with said screw.

12. The insulator as set forth in claim 6, wherein said socket is in longitudinal alignment with said screw.
